(19) United States
(12) Patent Application Publication
(10) Pub. No.: US 2012/0272699 A1
(43) Pub. Date: Nov. 1, 2012

(54) LOCK-KEY SYSTEM

(75) Inventors: Peter Meissner, Berlin (DE); Joachim Gillert, Berlin (DE)

(73) Assignee: ASSA ABLOY SICHERHEITSTECHNIK GMBH, ALBSTADT (DE)

(21) Appl. No.: 13/501,987

(22) PCT Filed: Oct. 8, 2010
(86) PCT No.: PCT/DE10/01191

§ 371 Date: Jun. 27, 2012

(30) Foreign Application Priority Data
Oct. 16, 2009 (DE) 20 2009 014 283.3
Nov. 4, 2009 (DE) 20 2009 015 088.7
Jan. 28, 2010 (DE) 10 2010 006886.1

(51) Int. Cl. E05B 19/02; E05B 19/06

(52) U.S. Cl. 70/406; 70/402

(57) ABSTRACT

A lock-key system includes a key that can be inserted into a keyway of a lock cylinder, wherein said key is traceable by core pins or by locking elements which are movable in the cylinder core, wherein if there is a match, the cylinder core can be rotated by means of the inserted key. Lettering in the form of an impression and/or an embossment, serving as an identifier and including letters and/or numbers and/or symbols, is introduced into at least one lateral surface of the key shank—if a lateral profiling is present, into said lateral profiling. The lettering or individual letters, numbers, or the symbol or sub-areas thereof are traceable by core pins or locking elements having a correspondingly formed contact surface.

The invention relates to a lock-key system, with a key which can be inserted into a keyway of a locking cylinder, and which is traceable by core pins or by locking elements which are shiftable in the cylinder core, wherein in case of a match the cylinder core can be turned by the key.

These types of key systems are known.

Keys can be lost and have to be reordered, often however there is the demand to have additional keys made.

The copying of keys can be impeded by security cards which have to be presented for a reorder. The unauthorized copying however can hardly be prevented in praxis. This circumstance is not changed by protected profiles, since nowadays copying machines are on the market which are able to copy these profiles as well.

The invention is based on the object to provide a lock-key system which offers increased protection against unauthorized copying of keys.

This object is solved on one hand with a key-lock system, with a key which can be inserted into a keyway of a locking cylinder, and which is traceable by core pins or by locking elements which are shiftable in the cylinder core, wherein in case of a match the cylinder core can be turned by the key, in that a lettering in the form of an impression and/or embossment which serves as identifier and comprises and/or comprises letters and/or numbers and/or symbols is introduced on the side surfaces of the key shaft, and in that the lettering or individual letters, numbers or the symbol or partial areas of the same are traceable by core pins or locking elements, which are configured complementary in their contact surfaces.

In profiled flat keys, this object is solved with a lock-key system, with a flat key which can be inserted into a keyway of a locking cylinder, which flat key has profilings on the side surfaces of the key shaft which are formed as grooves and embossments and extend in longitudinal direction of the key shaft and which are at least partially traceable by core pins or locking elements which are shiftable in the cylinder core and which interact with recesses in the cylinder housing which lie outside of the separation plane cylinder core/cylinder housing, wherein in case of a match the cylinder can be turned by the key , in that a lettering in the form of an impression and/or embossment which serves as identifier and comprises and/or comprises letters and/or numbers and/or symbols is introduced on the side surfaces of the key shaft, and in that the lettering or individual letters, numbers or the symbol or partial areas of the same is or are traceable by core pins or locking elements, which are configured complementary in their contact surfaces.

Preferably, the lettering, individual letters, numbers or symbols which serve as identifier should represent an identification which is registered as trademark.

In this type of lock-key system the locking process can only be carried out when the core pins or locking elements match at the separation plane cylinder core/cylinder housing, i.e. a matching key was inserted into the keyway, because the tracing of the identifier is additionally required.

The copying of the identifier requires special tools in contrast to the milling devices with which the profilings are produced on the key.

In addition, when a protected lettering or a corresponding letter or number combination or a protected logo forms the identifier, imitation can trigger an infringement process which is not without consequences for the imitator.

In the following, the invention is explained with reference to the exemplary embodiments shown in the drawings.

It is shown in

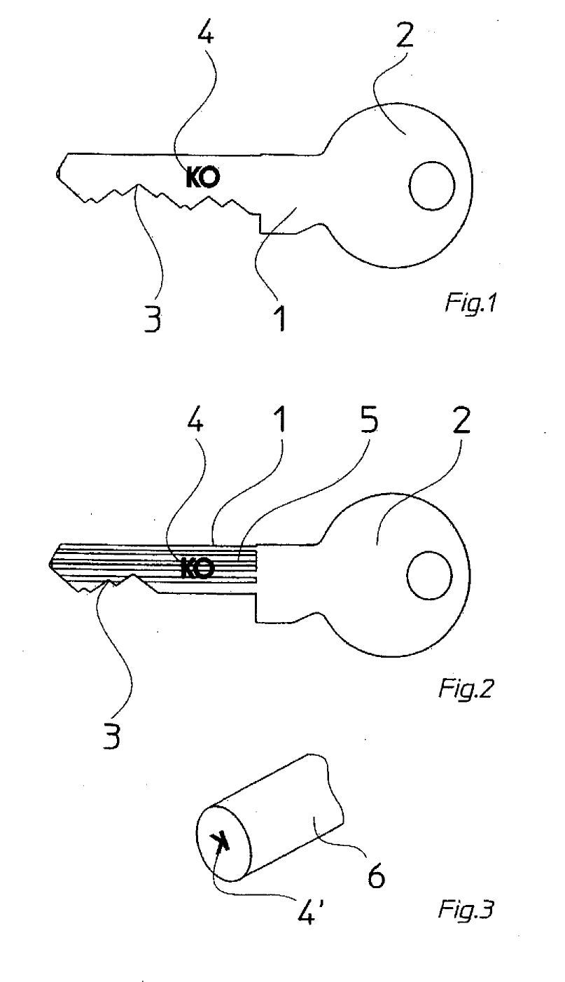

FIG. 1 schematically a flat key without lateral profiling and

FIG. 2 schematically a flat key with lateral profiling

FIG. 3 schematically a core pin with its contact surface.

In both Figures corresponding parts are designated the same.

Both flat keys have a bow 2 and a shaft 1. Grooves 3 are provided on the key chest. These interact in a conventional way with core and housing pins.

In FIG. 2 the groove are shown symbolically only over a partial length of the shaft. In the embodiment according to FIG. 2 profilings extend along the shaft in the form of longitudinal grooves and embossments.

According to the invention, an identifier 4 is worked in at least on one of the longitudinal sides of the shaft—in the embodiment according to FIG. 2 in addition to the profiling—which identifier in the shown example is formed by the letters “KO”.

This identifier should preferably be a registered, i.e. protected, trademark, wherein it can be a lettering, letter, numbers or symbols (logos).

Relevant is that not only the profiling of the key—if present—is mechanically scanned, but also the identifier 4. This takes place by core pins or other locking elements which are displaceable, i.e. shiftable, in the cylinder core. In FIG. 3 a core pin is indicated as example, which has a corresponding contact surface 4′. The later is formed in its entirety or only partially depending on the topography of ₜhe identifier on the key. However, it is relevant that these core pins have contact surfaces which correspond to the identifier which is introduced on the sides of the key, i.e. surfaces which can be brought into engagement with the identifier, which have positive or negative regions which correspond to the identifier.

These core pins or locking elements form a type of stamp in the region of contact.

Thus, for causing a match of the core pins or locking elements at the separation plane cylinder core/ cylinder housing the match between the identifier with the region contained on the core pin or locking element is necessary.

The impressions or embossments of these regions can vary and thus even increase the complexity of the key-lock system.

The relevant difference to the simple lateral pin query is thus that not only one point or plane, but an entire contour and/or topography can be queried.

A copy of this type of keys thus requires significantly more effort or is even impossible and on the other hand represents an infringement in the case of imitation of a protected trade mark.

1.-3. (canceled)

4. A lock-key system, comprising:
a key insertable into a keyway of a lock cylinder and having a shaft, said shaft having side surfaces, wherein at least one of the side surfaces is provided with a lettering in form of impressions and/or embossments, said lettering comprising at least one member selected from the group consisting of a letter, a number and a symbol; and
locking elements movable in a cylinder core of the lock cylinder and having contact surfaces corresponding to the member, said locking elements configured for tracing the key and the member or sub areas thereof, wherein a match resulting from said tracing enables a turning of the cylinder core.

5. A lock-key system, comprising:
a flat key insertable into a keyway of a lock cylinder, said flat key having a shaft, said shaft having side surfaces, said side surfaces being provided with profilings formed as grooves and elevations and extending in longitudinal direction along the shaft, said profilings being provided with a lettering in the form of impressions and/or embossments, said lettering comprising at least one member selected from the group consisting of a letter, a number and a symbol; and
locking elements movable in a cylinder core of the lock cylinder, said locking elements having contact surfaces which correspond to the member and configured for interacting with recesses provided in a cylinder housing of the lock cylinder outside a separation plane between the cylinder core and the cylinder housing, wherein the locking elements are configured for tracing the member or sub-areas thereof and at least in part the profilings, and wherein a match resulting from said tracing enables a turning of the cylinder core.

6. The lock-key system of claim 4, wherein the member at least in part represents a registered trademark.

7. The lock-key system of claim 5, wherein the member at least in part represents a registered trademark.
